(19) United States
(12) Patent Application Publication
(10) Pub. No.: US 2003/0055648 A1
(43) Pub. Date: Mar. 20, 2003

(54) Method, apparatus and computer program product for implementing preselection announce for user selectable buttons

(76) Inventor: Brian John Cragun, Rochester, MN (US)

Correspondence Address: Leslie J. Payne, IBM Corporation - Dept. 917, 3605 Highway 52 North, Rochester, MN, 55901, US

(21) Appl. No.: 09/953,331

(22) Filed: Sep. 14, 2001

(51) Int. Cl. G10L 21/00; G10L 11/00

(52) U.S. Cl. 704/270

(57) ABSTRACT

A method, apparatus and computer program product implement preselection announce for user selectable buttons in a computer system. The computer system includes a processor coupled to the multiple user selectable buttons and a memory for storing a preselection announce program and a button record for each of the multiple user selectable buttons. The processor monitors for a button touch. Responsive to identifying a button touch, a function for the button is identified and audio data for the button is announced. Responsive to identifying a button touch, video data for the button also is displayed. The processor checks for a button press and responsive to identifying a button press, performs the function for the user-selected button.

### FIELD OF THE INVENTION

The present invention relates generally to the data processing field, and more particularly, relates to a method, apparatus and computer program product for implementing preselection announce for user selectable buttons.

### DESCRIPTION OF THE RELATED ART

In many circumstances, it is hard to see the function of a physical button before you press it. For example, when driving in the car while keeping eyes on the road, or fumbling for buttons on a clock radio in the dark, or when you are looking through the viewfinder of a camera and want to press the correct button on the side of the camera, or using a wearable computer with buttons embedded on clothing.

Furthermore, there are many buttons having different functions depending on other circumstances, for example, radio pre-sets or function keys on a computer keyboard. It can be hard to remember what functions that button provides.

A need exists for a method, apparatus and computer program product for implementing preselection announce for user selectable buttons. It is desirable to provide such method, apparatus and computer program product for implementing preselection announce for user selectable buttons that dynamically solves the problem of knowing a function of a physical button before the button is pressed.

### SUMMARY OF THE INVENTION

A principal object of the present invention is to provide a method, apparatus and computer program product for implementing preselection announce for user selectable buttons. Other important objects of the present invention are to provide such method, apparatus and computer program product for implementing preselection announce for user selectable buttons substantially without negative effect and that overcome many of the disadvantages of prior art arrangements.

In brief, a method, apparatus and computer program product are provided for implementing preselection announce for user selectable buttons in a computer system. The computer system includes a processor coupled to the multiple user selectable buttons and a memory for storing a preselection announce program and a button record for each of the multiple user selectable buttons. The processor monitors for a button touch. Responsive to identifying a button touch, a function for the button is identified and audio data for the button is announced.

In accordance with features of the invention, responsive to identifying a button touch, video data for the button is displayed. The processor checks for a button press and responsive to identifying a button press, performs the function for the user selected button.

### BRIEF DESCRIPTION OF THE DRAWINGS

The present invention together with the above and other objects and advantages may best be understood from the following detailed description of the preferred embodiments of the invention illustrated in the drawings, wherein:

FIG. 1 is a block diagram representation illustrating a computer system for implementing preselection announce for user selectable buttons in accordance with the preferred embodiment;

FIG. 2 is a diagram illustrating a button record in accordance with the preferred embodiment;

FIG. 3 is a flow chart illustrating exemplary sequential steps for implementing preselection announce for user selectable buttons in accordance with the preferred embodiment; and

FIG. 4 is a block diagram illustrating a computer program product in accordance with the preferred embodiment.

### DETAILED DESCRIPTION OF THE PREFERRED EMBODIMENTS

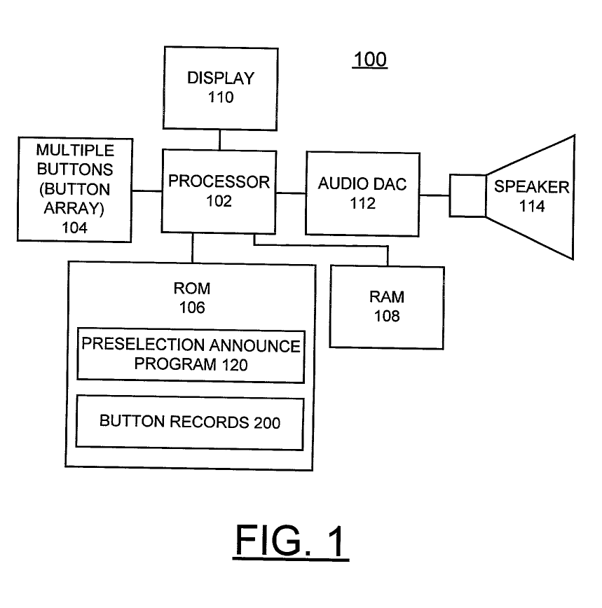

Having reference now to the drawings, in FIG. 1, there is shown a computer system generally designated by the reference character 100 for implementing preselection announce for user selectable buttons of the preferred embodiment. As shown in FIG. 1, computer system 100 includes a central processor unit (CPU) 102, a plurality of buttons or button array 104, a read only memory (ROM) 106, a random access memory (RAM) 108, and a display 110. CPU 102 is connected to an audio digital-to-analog converter (DAC) 112 that applies an analog signal to a speaker 114. ROM 108 stores a preselection announce program 120 of the preferred embodiment and a plurality of button records 200 for multiple user selectable buttons 104.

In accordance with features of the preferred embodiment, computer system 100 implements preselection announce for user selectable buttons for the physical world, dynamically solving the problem of knowing a function of a physical button before the button is pressed. Computer system 100 advantageously is provided in many different physical environments, such as, an automobile, a camera, a clock radio, a portable computer, and the like.

In accordance with features of the preferred embodiment, preselection announce program 120 causes a button's function to be spoken aloud when the fingers lightly touch the button. Sensors in each button 104 detect a condition equal to touch but not a press. In the preferred embodiment sensing a button touch is provided by an electrical capacitance discharge circuit included with each button 104 for providing a button touch signal in addition to the regular button press signal. However, it should be understood that other sensing arrangements can be used, such as light sensors, or proximity sensors. Two stage or triple state buttons could be used in the alternative. Also alternatively, force sensing buttons can be used for buttons 104, where a low threshold indicates a touch and a high threshold indicates a press. When a button touch condition is detected, an appropriate sound file of the respective button record 200 is accessed and played over the associated speaker 114. For buttons 104 with re-assignable function, the current function is queried and sounded.

In accordance with features of the preferred embodiment, preselection announce program 120 optionally causes the button's function to be displayed in a place more convenient to viewing on display 110. For example, in an automobile, the button's function can be displayed on the windshield in a heads-up display 110; on a clock radio, the function could be displayed on a LED display 110 or projected on the ceiling; in the camera, the function can be provided in the viewfinder display 110 before pressing; in a wearable computer the function could be sounded in the earpiece speaker 114 or on the heads-up eyepiece display 110.

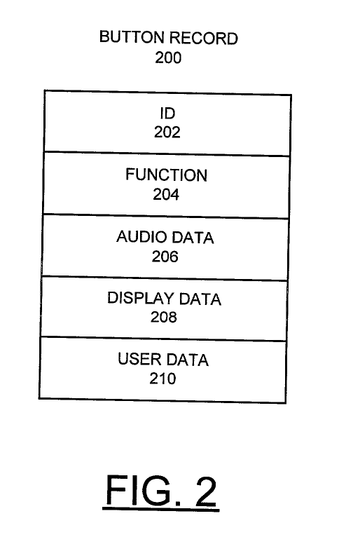

Referring now to FIG. 2, there is shown an exemplary button record 200 of the preferred embodiment. As shown in FIG. 2, button record 200 includes multiple fields including a button identification (ID) 202, a button function 204, audio data 206, display data 208 and user data 210. For each of the multiple buttons 104 in the computer system 100 of FIG. 1, a respective button record 200 is stored, for example, in ROM 106.

In accordance with features of the preferred embodiment, the signals for each button 104 and its corresponding touch sensor are addressed such that the common part of their address can be used for the button record comparison, with the difference determining whether it is a touch or press in process. Alternatively, separate address values could be kept in record 200 in addition to the ID for comparison.

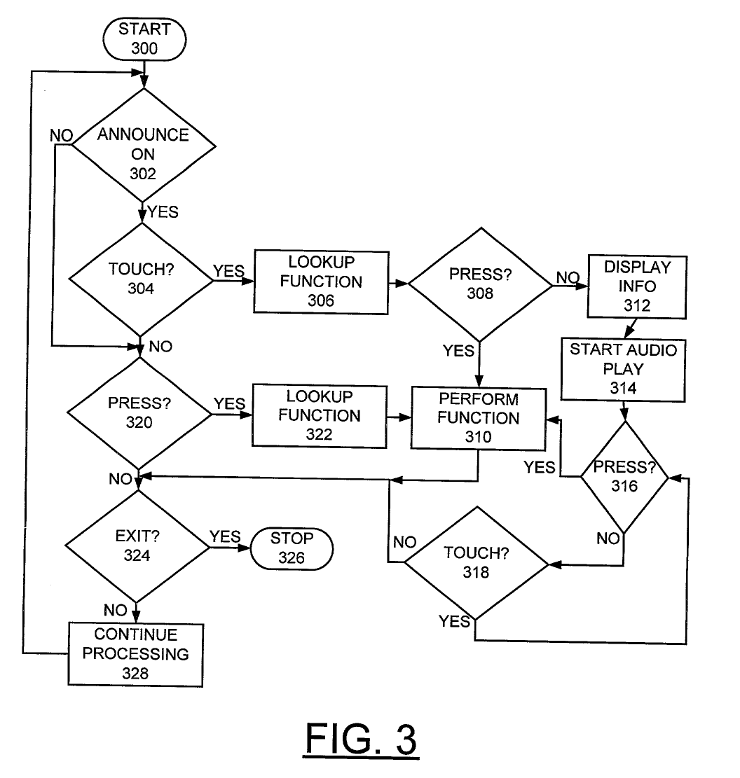

Referring now to FIG. 3, there are shown exemplary steps for implementing preselection announce for user selectable buttons in accordance with the preferred embodiment starting at block 300. Checking for announce on or the preselection announce program 120 being enabled is performed as indicated in a decision block 302. When the preselection announce program 120 is enabled, monitoring or checking for a button touch is performed as indicated in a decision block 304. When a button touch is identified for a particular button 104, lookup of the button function 204 is provided as indicated in a block 306. The lookup function uses, for example, the wired address of the button 104 to identify the button and for comparison relative to the button records 200. Obviously, various other methods could be used to identify the buttons 104 including, such as, button identifiers sent as serial bits over an internal bus of system 100. Monitoring for a button press is performed as indicated in a decision block 308. When a button press is identified for a particular button 104, the button function is performed as indicated in a block 310.

In the preferred embodiment, when a button 104 is pressed, and the touch stage is momentary, pre-announcement is bypassed. Obviously, this feature could be bypassed and the preannounce could occur in all press detections.

When a button press is not identified at decision block 308, the display data 208 for the particular button 104 is displayed as indicated in a block 312. Next the audio data 208 for the particular button 104 is played as indicated in a block 314. Checking for a button press is performed as indicated in a decision block 316. When a button press is identified for a particular button 104 at decision block 316, then the button function is performed at block 310. Otherwise, when a button press is not identified at decision block 316, checking for a button touch is performed as indicated in a decision block 318. When a button touch is identified at decision block 318, then checking for a button press is continued at decision block 316.

When determined at decision block 302 that the preselection announce program 120 is not enabled, then checking for a button press is performed as indicated in a decision block 320. When a button press is identified for a particular button 114 at decision block 320, the button function is looked-up as indicated in a block 322. Then the button function is performed at block 310. After performing the button function at block 310, processing continues to a decision block 324 where checking for exit is performed. When a button press is not identified at decision block 320 and when a button touch is not identified at decision block 318, then checking for exit is performed as indicated in a decision block 324. When exit is identified, then the operations stop as indicated in a block 326. Otherwise, when exit is not identified, then processing continues as indicated in a block 328. The sequential steps return to decision block 302 and are repeated as described above.

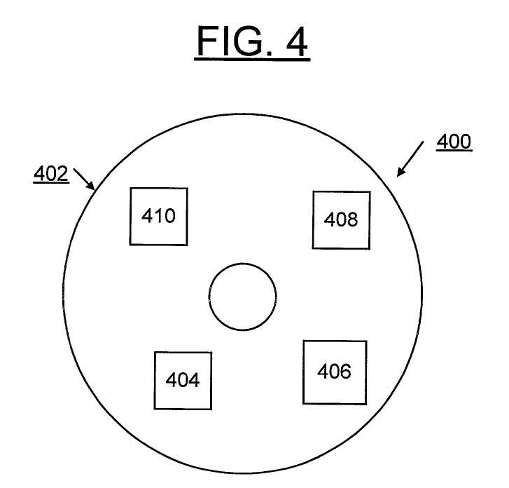

Referring now to FIG. 4, an article of manufacture or a computer program product 400 of the invention is illustrated. The computer program product 400 includes a recording medium 402, such as, a floppy disk, a high capacity read only memory in the form of an optically read compact disk or CD-ROM, a tape, a transmission type media such as a digital or analog communications link, or a similar computer program product. Recording medium 402 stores program means 404, 406, 408, 410 on the medium 402 for carrying out the methods for implementing preselection announce for user selectable buttons of the preferred embodiment in the system 100 of FIG. 1.

A sequence of program instructions or a logical assembly of one or more interrelated modules defined by the recorded program means 404, 406, 408, 410, direct the computer system 100 for implementing preselection announce for user selectable buttons of the preferred embodiment.

While the present invention has been described with reference to the details of the preferred embodiments, it should be understood that monitoring for button touch is not limited to monitoring for a physical touching of a respective button. For example, monitoring for button touch should be understood to include the use of buttons with proximity sensors, where a button touch is identified responsive to the detected nearness of the user to a respective proximity sensor. It should be understood that monitoring for button touch includes time threshold monitoring of a user's button selection where a button touch is identified responsive to a short time threshold and a button press is identified responsive to a longer time threshold.

While the present invention has been described with reference to the details of the embodiments of the invention shown in the drawing, these details are not intended to limit the scope of the invention as claimed in the appended claims.

What is claimed is:

1. A computer-implemented method for implementing preselection announce for multiple user selectable buttons in a computer system comprising the steps of:
monitoring for a button touch,
responsive to identifying a button touch, identifying a function for the button, and
responsive to identifying a button touch, announcing audio data for the button.

2. A computer-implemented method for implementing preselection announce for multiple user selectable buttons as recited in claim 1 further includes the step of responsive to identifying a button touch, displaying display data for the button.

3. A computer-implemented method for implementing preselection announce for multiple user selectable buttons as recited in claim 1 further includes the step, checking for a button press for the button, responsive to not identifying a button press, displaying display data for the button, and responsive to identifying a button press, performing said identified function for the button.

4. A computer-implemented method for implementing preselection announce for multiple user selectable buttons as recited in claim 1 further includes the steps of storing a button record for each of the multiple user selectable buttons.

5. A computer-implemented method for implementing preselection announce for multiple user selectable buttons as recited in claim 4 wherein the step storing said button record for each of the multiple user selectable buttons includes the steps of storing a button identification, a button function, audio data, and display data in said button record for each of the multiple user selectable buttons.

6. A computer-implemented method for implementing preselection announce for multiple user selectable buttons as recited in claim 5 wherein the step, responsive to identifying a button touch, of identifying said function for the button, includes the steps of look-up of said button function for the user selected button in said button record for the button and checking for a button press for the button.

7. A computer-implemented method for implementing preselection announce for multiple user selectable buttons as recited in claim 6 wherein the step responsive to identifying said button touch, of announcing audio data for the button includes the steps responsive to not identifying a button press, of look-up of said audio data for the user selected button in said button record for the button.

8. A computer-implemented method for implementing preselection announce for multiple user selectable buttons as recited in claim 7 includes the step of applying said audio data for the user selected button to a digital-to-analog converter (DAC) to produce an analog audio signal and applying said analog audio signal to a speaker for announcing audio data for the button.

9. A computer-implemented method for implementing preselection announce for multiple user selectable buttons as recited in claim 5 further includes the steps of, checking for a button press for the button, and responsive to not identifying a button press, look-up of said display data for the user selected button in said button record for the button and displaying said display data for the button.

10. A computer-implemented method for implementing preselection announce for multiple user selectable buttons as recited in claim 5 wherein the step storing said button record includes storing user data.

11. Apparatus for implementing preselection announce for multiple user selectable buttons comprising:
a processor;
a memory coupled to said processor; said memory storing a button record for each of the multiple user selectable buttons; said memory storing a preselection announce program for operatively controlling said processor;
said processor for monitoring for a button touch, responsive to identifying a button touch, for identifying a function for the button, and for announcing audio data for the button.

12. Apparatus for implementing preselection announce for multiple user selectable buttons as recited in claim 11 includes a speaker and an audio digital-to-analog converter (DAC) coupled to said processor; said audio DAC for producing an analog audio signal and applying said analog audio signal to said speaker for announcing audio data for the button.

13. Apparatus for implementing preselection announce for multiple user selectable buttons as recited in claim 11 includes a display coupled to said processor; said display for displaying display data for the button responsive to said processor identifying a button touch.

14. Apparatus for implementing preselection announce for multiple user selectable buttons as recited in claim 11 wherein each said button record for each of the multiple user selectable buttons includes predefined ones of a button identification, a button function, audio data, display data and user data.

15. Apparatus for implementing preselection announce for multiple user selectable buttons as recited in claim 11 wherein said processor for monitoring for a button press; and said processor responsive to not identifying a button press and responsive to identifying a button touch, for announcing audio data for the button; and said processor responsive to identifying a button press for performing said identified function for the button.

16. A computer program product for implementing preselection announce for multiple user selectable buttons in a computer system including a processor coupled to the multiple user selectable buttons, said computer program product including a plurality of computer executable instructions stored on a computer readable medium, wherein said instructions, when executed by said processor, cause said processor to perform the steps of:
monitoring for a button touch,
responsive to identifying a button touch, identifying a function for the button, and
responsive to identifying said button touch, announcing audio data for the button.

17. A computer program product for implementing preselection announce for multiple user selectable buttons as recited in claim 16 wherein said instructions, when executed by said processor, further cause said processor to perform the step of displaying display data for the button responsive to identifying said button touch.

18. A computer program product for implementing preselection announce for multiple user selectable buttons as recited in claim 16 wherein said instructions, when executed by said processor, further cause said processor to perform the steps of storing a button record for each of the multiple user selectable buttons.

19. A computer program product for implementing preselection announce for multiple user selectable buttons as recited in claim 16 wherein said instructions, when executed by said processor, further cause said processor to perform the steps of storing a button identification, a button function, audio data, and display data in a button record for each of the multiple user selectable buttons.

20. A computer program product for implementing preselection announce for multiple user selectable buttons as recited in claim 16 wherein said instructions, when executed by said processor, further cause said processor to perform the steps of monitoring for a button press, and responsive to identifying a button press, performing said identified function for the button.
